(19) United States
(12) Patent Application Publication
(10) Pub. No.: US 2026/0022978 A1
(43) Pub. Date: Jan. 22, 2026

(54) SYSTEM AND METHOD OF TEMPERATURE SENSING USING INTERNAL HEATFLOW CANCELLATION

(71) Applicant: Apple Inc., Cupertino, CA (US)

(72) Inventor: Adriaan J. TAAL, San Diego, CA (US)

(21) Appl. No.: 19/236,363

(22) Filed: Jun. 12, 2025

Related U.S. Application Data
(60) Provisional application No. 63/673,653, filed on Jul. 19, 2024.

(51) Int. Cl. G01K 7/42; G01K 13/20

(52) U.S. Cl. CPC G01K 7/427; G01K 13/20

(57) ABSTRACT

In various embodiments, an electronic device encompasses a housing, a first temperature sensor, a second temperature sensor, a heating element, and processing circuitry. This processing circuitry is configured to execute a method for the measurement of a temperature external to the electronic device. The temperature is derived through the calculation of heat flux between the first and second temperature sensors.

### CROSS-REFERENCE TO RELATED APPLICATION

This application claims the benefit of U.S. Provisional Application No. 63/673,653, filed Jul. 19, 2024, the contents of which are incorporated herein by reference in its entirety for all purposes.

### FIELD OF THE DISCLOSURE

This disclosure relates generally to an electronic device incorporating a temperature sensing device, and more particularly, to an electronic device incorporating a temperature sensing device with a plurality of temperature sensors.

### BACKGROUND OF THE DISCLOSURE

Aspects of this disclosure relate to temperature sensing devices including architecture robust against internal and external temperature influences. Common strategies employing temperature sensing devices, while effective, are often susceptible to internal and/or external extraneities temperature influences.

SUMMARY OF THE DISCLOSURE

This disclosure relates generally to an electronic device incorporating a temperature sensing device, and more particularly, to an electronic device incorporating a temperature sensing device with a plurality of temperature sensors. In some examples, a wearable device, such as a smart watch, includes a temperature sensing device with a plurality of temperature sensors and a heating element. The temperature sensing device optionally takes measurements the electronic device uses to calculate a temperature measurement (e.g., an ambient temperature measurement). In some examples, the temperature sensing device calculates the temperature measurement derived from a heat flux between a first temperature sensor and a second temperature within the temperature sensing device. In some examples, the first temperature sensor is thermally isolated from the heating element while the second temperature sensor and the heating element are thermally isolated from a portion of the interior of the electronic device thermally coupled to the first temperature sensor. This approach increases the temperature sensing device resistance to external temperature factors, providing a more accurate temperature measurement.

The full descriptions of the embodiments are provided in the Drawings and the Detailed Description, and it is understood that the Summary of the Disclosure provided above does not limit the scope of the disclosure in any way.

### BRIEF DESCRIPTION OF THE DRAWINGS

For a better understanding of the various described examples, reference should be made to the Detailed Description below, in conjunction with the following drawings in which like reference numerals refer to the corresponding parts throughout the figures.

FIGS. 1A-1K illustrate example electronic devices that can include a temperature sensing device for estimating a temperature outside the device (e.g., ambient temperature) according to some examples of the disclosure.

FIG. 2 illustrates a block diagram of a computing system of an exemplary electronic device that includes the temperature sensing device according to some examples of the disclosure.

FIG. 3 illustrates example of a wearable electronic device including the temperature sensing device and a top-down view of the temperature sensing device further comprising a plurality of components including a first temperature sensor, a second temperature sensor, and a heating element according to some examples of the disclosure.

FIG. 4 illustrates examples of the wearable device including the temperature sensing device disposed on an arm of a user, and a cross-sectional view of the temperature sensing device further including the first temperature sensor, the second temperature sensor, and the heating element according to some examples of the disclosure.

FIGS. 5-7 illustrates examples of a first heat flux at the temperature sensing device at a first time and a second heat flux at the temperature sensing device at a second time according to some examples of the disclosure.

FIG. 8 is a flow diagram illustrating a method of generating a temperature measurement associated with an environment according to some examples of the disclosure.

### DETAILED DESCRIPTION

In the following description of embodiments, reference is made to the accompanying drawings which form a part hereof, and in which it is shown by way of illustration specific embodiments that are optionally practiced. It is to be understood that other embodiments are optionally used, and structural changes are optionally made without departing from the scope of the disclosed embodiments.

The present disclosure relates to various examples for providing ambient temperature measurements for a user using a wearable device, in accordance with some examples. In the following description of examples, reference is made to the accompanying drawings which form a part hereof, and in which is shown by way of illustration specific examples that can be practiced. It is to be understood that other examples can be used and structural changes can be made without departing from the scope of the disclosed examples.

Although the following description uses terms “first,” “second,” etc. to describe various elements, these elements should not be limited by the terms. These terms are only used to distinguish one element from another. For example, a first touch could be termed a second touch, and, similarly, a second touch could be termed a first touch, without departing from the scope of the various described embodiments. The first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

### Exemplary Devices

Example temperature sensing devices of electronic devices and methods that utilize multiple temperature sensors are disclosed. An electronic device can leverage measurements from a plurality of temperature sensors, including, for example, a first temperature sensor at a first location in the device and a second temperature sensor at a second location in the device, to estimate temperature outside the device (e.g., temperature of the surrounding air (e.g., ambient air temperature)). In some examples, estimating temperatures outside of the electronic device is a function of a first temperature measurement from the first temperature sensor, a second temperature measurement from the second temperature sensor, and one or more thermal resistance values corresponding to various locations or regions inside and/or outside the device. In some examples, an electronic device leverages measurements from a plurality of temperature sensors, including, for example, at least two temperature sensors (e.g., 2, 3, or 4 temperature sensors), to measure and/or estimate ambient temperature.

In the discussion that follows, an electronic device that includes a display and a touch-sensitive surface is described. It should be understood, however, that the electronic device optionally includes one or more other physical user-interface devices, such as a physical keyboard, a mouse and/or a joystick. Further, as described above, it should be understood that the described electronic device, display and touch-sensitive surface are optionally distributed amongst two or more devices. Therefore, as used in this disclosure, information displayed on the electronic device or by the electronic device is optionally used to describe information outputted by the electronic device for display on a separate display device (touch-sensitive or not). Similarly, as used in this disclosure, input received on the electronic device (e.g., touch input received on a touch-sensitive surface of the electronic device) is optionally used to describe input received on a separate input device, from which the electronic device receives input information.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable or non-portable devices with touch-sensitive displays, though the devices need not include touch-sensitive displays or displays in general, as described above.

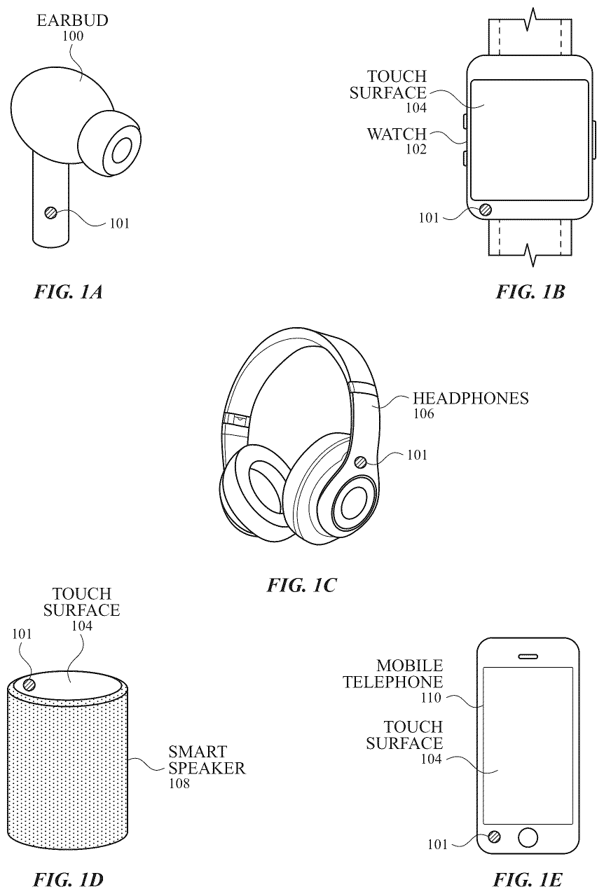

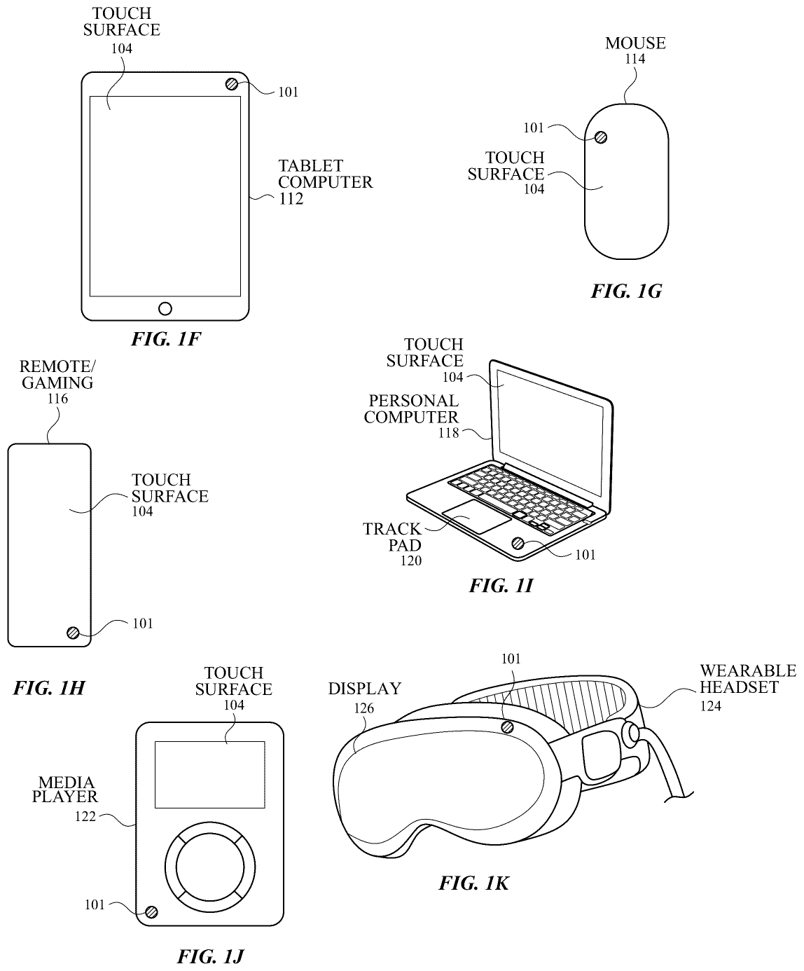

FIG. 1A illustrates an example earbud 100 that can include a temperature sensing device 101 for estimating a sensed temperature according to some examples of the disclosure. FIG. 1B illustrates an example watch 102 that includes touch surface 104 and can include a temperature sensing device 101 for estimating a sensed temperature according to some examples of the disclosure. FIG. 1C illustrates example headphones 106 that can include a temperature sensing device 101 for estimating a sensed temperature according to some examples of the disclosure. FIG. 1D illustrates an example smart speaker 108 that includes touch surface 104 and can include a temperature sensing device 101 for estimating a sensed temperature according to some examples of the disclosure. FIG. 1E illustrates an example mobile telephone 110 that includes touch surface 104 and can include a temperature sensing device 101 for estimating a sensed temperature according to some examples of the disclosure. FIG. IF illustrates an example tablet computing device 112 that includes touch surface 104 and can include a temperature sensing device 101 for estimating a sensed temperature according to some examples of the disclosure. FIG. 1G illustrates an example mouse 114 that includes touch surface 104 and can include a temperature sensing device 101 for estimating a sensed temperature according to some examples of the disclosure. FIG. 1H illustrates an example remote or gaming control 116 that includes touch surface 104 and can include a temperature sensing device 101 for estimating a sensed temperature according to some examples of the disclosure. FIG. 1I illustrates an example personal computer 118 that includes touch surface 104 and track pad 120 and can include a temperature sensing device 101 for estimating a sensed temperature to some examples of the disclosure. FIG. 1J illustrates an example digital media player 122 that includes touch surface 104 and can include a temperature sensing device 101 for estimating a sensed temperature according to some examples of the disclosure. FIG. 1K illustrates an example wearable headset 124 that includes display 126 and can include a temperature sensing device 101 for estimating a sensed temperature according to examples of the disclosure.

It should be understood that the example devices illustrated in FIGS. 1A-1K are provided by way of example, and other types of devices can include temperature sensing device 101 for estimating a sensed temperature outside the devices. For example, the devices can include devices worn on or placed into contact with the face, the head, cars, or the fingers of a user (or at another location on a user's body). The devices can include over-ear headphones, glasses, head bands, chest straps, wrist straps, rings, etc.

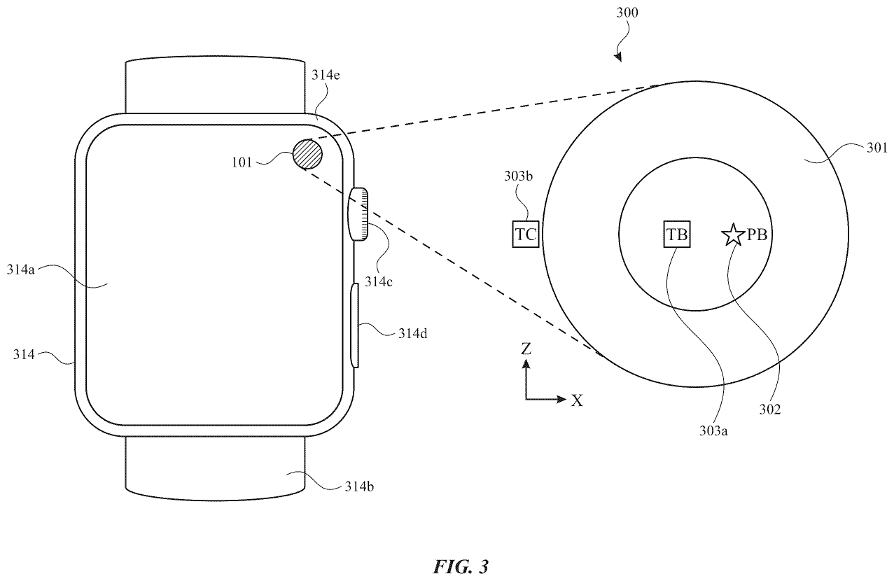

As described herein, a temperature sensing device can be incorporated into the electronic devices shown in FIGS. 1A-1K to add external temperature sensing capabilities to the devices. In some examples, the temperature sensing device can be optionally incorporated in the aforementioned electronic device to calculate an ambient temperature. In particular, the use a plurality of temperature sensors, thermally isolated from one another, as described herein can enable more accurate estimates because thermally isolated temperature sensors can reduce the impact of thermal aggressors (e.g., heat sources within a device, such as heat generating components within the device) and can also reduce the overall drift or other error in a temperature estimate (e.g., process, voltage, and/or temperature variations in the temperature sensors, influence from thermal aggressors, etc.). For example, a first temperature sensor and a second temperature sensor can optionally be placed within the housing of any of the electronic devices shown in FIGS. 1A-1K at an equal depth from a surface of the respective device discussed in further detail below with reference to FIG. 3, via the method 800 discussed in further detail below.

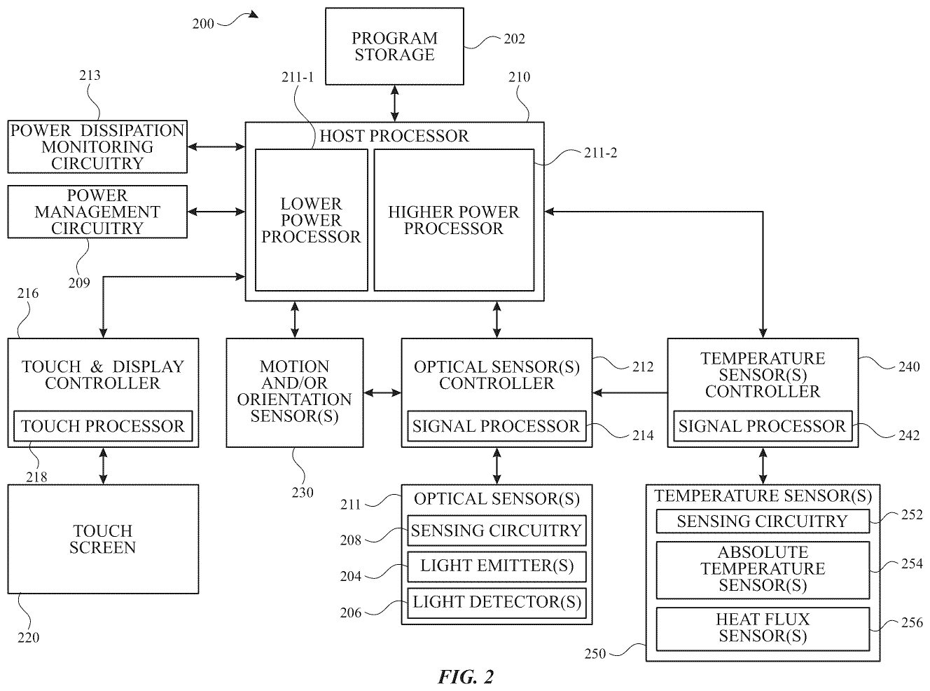

FIG. 2 illustrates a block diagram of a computing system of an exemplary electronic device that includes a temperature sensing device according to some examples of the disclosure. Although primarily described herein as a wearable device, the computing system may alternatively be implemented partially or fully in a non-wearable device. For example, the sensors and/or processing described herein can be implemented partially or fully in a mobile telephone, media player, tablet computer, personal computer, server, etc. In some examples, the optical sensors (e.g., light emitters and light detectors) and/or temperature sensors (e.g., temperature sensor(s) or heat flux sensors) can be implemented in a wearable device (e.g., a wristwatch) and the processing of the optical and/or temperature data can be performed in a non-wearable device (e.g., a mobile phone). In some examples, the temperature sensors, such as first temperature sensor 303b and second temperature sensor 303a (see FIG. 3), can be implemented in a wearable device, and the processing of the data can be performed in a non-wearable device. Processing and/or storage of the optical and/or temperature data in a separate device can enable the device including the physiological sensors (e.g., a wristwatch) to be space and power efficient (which can be important features for portable/wearable devices).

Computing system 200 can correspond to earbud 100, watch 102, headphones 106, smart speaker 108, mobile telephone 110, tablet computer 112, mouse 114, remote/gaming 116, personal computer 118, and/or media player 122 above illustrated in FIGS. 1A-1K (or may be implemented in other wearable or non-wearable electronic devices). Computing system 200 can include a processor 210 (or more than one processor) programmed to (configured to) execute instructions and to carry out operations associated with computing system 200. For example, using instructions retrieved from program storage 202, processor 210 can control the reception and manipulation of input and output data between components of computing system 200. Processor 210 can be a single-chip processor (e.g., an application specific integrated circuit) or can be implemented with multiple components/circuits. For example, FIG. 2 illustrates that processor 210 can include a relatively lower power processor 211-1 and a relatively higher power processor 211-2, as described in more detail herein.

In some examples, processor 210 together with an operating system can operate to execute computer code and produce and/or use data. The computer code and data can reside within a program storage 202 that can be operatively coupled to processor 210. Program storage 202 can generally provide a place to hold data used by computing system 200. Program storage block 202 can be any non-transitory computer-readable storage medium. By way of example, program storage 202 can include Read-Only Memory (ROM), Random-Access Memory (RAM), hard disk drive and/or the like. The computer code and data could also reside on a removable storage medium and loaded or installed onto computing system 200 when needed. Removable storage mediums include, for example, CD-ROM, DVD-ROM, Universal Serial Bus (USB), Secure Digital (SD), Compact Flash (CF), Memory Stick, Multi-Media Card (MMC) and/or a network component.

As described herein, in some examples, host processor 210 can represent multiple processors, such as lower power processor 211-1 and higher power processor 211-2. Lower power processor 211-1 and higher power processor 211-2 can represent separate processing chips, each with independent timing and power requirements. For example, lower power processor 211-1 can operate using a first clock signal and at a first power level that allows processor 211-1 to remain operational (“on”) across most or all operating modes of system 200 (e.g., a sleep mode, awake mode, idle mode, etc.). By contrast, higher power processor 211-2 can operate using a second clock signal (e.g., a higher frequency clock), different from the first, and at a second power level, higher than the first. Because of the higher power requirements of higher power processor 211-2, host processor 210 (e.g., an operating system on processor 210) can selectively disable, or power down higher power processor 211-2 or otherwise throttle its power consumption during certain operating modes of system 200 (e.g., a power saving mode, sleep mode, etc.). In some examples, as described herein, the higher power processor 211-1 can be powered down or otherwise throttle its power consumption to enable temperature measurements without error introduced by the power dissipation by higher power processor 211-1.

Lower power processor 211-1 and/or higher power processor can interface with various sensors of system 200 including a touch sensor panel and/or a touch screen 220 (via touch and display controller 216), motion and/or orientation sensor(s) 230, optical sensor(s) 211 (via optical sensor controller 212), and temperature sensor(s) 250 (via temperature sensor controller 240). In some examples, lower power processor 211-1 can operate in a sleep mode or a power-saving mode, while higher power processor 211-2 is powered down. In some examples, lower power processor 211-1 can change an operating mode of system 200 or otherwise cause higher power processor 211-2 to be powered on (e.g., when wake up conditions are detected).

Computing system 200 can also include power management circuitry 209 and/or power dissipation monitoring circuitry 213. Host processor 210 (e.g., lower power processor 211-1 and/or higher power processor 211-2) can be coupled to power management circuitry 209 and/or power dissipation monitoring circuitry 213. Power management circuitry 209 can regulate power delivery from power supply circuitry (e.g., a battery, or other power source of system 200) to various components of system 200 (e.g., sensors, processors, antennas, displays, etc.). As an example, power management circuitry 209 can interrupt or throttle power delivery to components that generate heat within system 200 (e.g., thermal aggressors), especially during temperature measurements that may be sensitive to heat from such components. Power management circuitry 209 can monitor temperatures inside a housing of system 200 and/or temperatures outside the housing (e.g., environmental temperatures, user skin/core temperature). As an example, power management circuitry 209 can monitor these temperatures to detect unsafe operating conditions for system 200 and can selectively interrupt or throttle power delivery to certain heat-generating components to bring system 200 into a safe operating condition. In some examples, power management circuitry 209 provides control signals to inline switches coupled between the power supply circuitry of system and various components of system 200, where the control signals determine an amount of current or power that can be delivered to the respective components. As an example, power management circuitry 209 can provide a first control signal to a switch interposed between a battery power source of system 200 and touch screen 220, such that the first control signal limits the amount of power or current delivered to the touch screen by the battery power source. As another example, power management circuitry 209 can provide a second control signal to a switch interposed between a battery power source of system 200 and antenna circuitry (not shown) of the system, such that the second control signal interrupts power delivery or current flow between the battery power source and the antenna circuitry.

Power dissipation monitoring circuitry 213 can monitor power supply circuitry of system 200 (not shown) and can regulate power delivery from the power supply circuitry to various components of system 200 (e.g., by sending instructions to power management circuitry 209). In some examples, power dissipation monitoring circuitry 213 includes a sensor coupled to the power supply circuitry (e.g., battery) of system 200. The sensor can measure power drawn by components of system 200 from the power supply circuitry (e.g., battery of system 200). In some examples, the power drawing by components of the system can be estimated based on a current draw from the power supply circuitry. In some examples, the power drawn can be estimated on a device basis (e.g., estimated current draw from the battery). In some examples, the power drawn can be estimated on a per-component basis for some (e.g., known thermal aggressors) or all of the components. In some examples, the power dissipation monitoring circuitry 213 includes at least one resistor (e.g., with a resistance greater than 10 MOhm, 20 MOhm, etc.) coupled between with the power supply circuitry or battery of system 200 and components of system 200 that draw power. A current through the resistor can be measured by determining a voltage across the resistor (e.g., periodically or in response to a trigger) and converting the voltage to a resistance (e.g., using Ohms law).

In some examples, computing system 200 (e.g., processor 210, power management circuitry 209, and/or power dissipation monitoring circuitry 213) can include power dissipation models that relate current/power draw from the power supply or battery of system 200 and temperature or heat dissipation within the device. Additionally, or alternatively, computing system 200 can include models for estimating the power consumption and/or resulted temperature changes by different components, in different operational modes of system 200 (e.g., power consumption by touch screen 220 in an idle mode, in a low-brightness mode, in a high-brightness mode, etc.). Impacts of the power consumption of certain components, or thermal aggressors of system 200, can be determined using lab characterizations of the components (e.g., a rise time, a fall time, and amplitude measured for each thermal aggressor at various respective power levels). Accordingly, computing system 200 can dynamically model temperatures within the system 200, based on power dissipation models, and one or more current/power draw measurement at the system's power supply circuitry or battery. In some examples, power management circuitry 209 can limit or interrupt the delivery of power to certain components, such as during a measurement interval associated with temperature sensors 250 (e.g., an interval where sensor data is collected from temperature sensors 250), based on information from power dissipation monitoring circuitry 213. As an example, when a power dissipation model indicated that an amount of power being drawn by components of system 200 corresponds to a temperature within the device outside of a range required for accurate and/or reliable operation of temperature sensors 250, power management circuitry 209 to limit or interrupt power to components of system 200 such that the total power drawn by the components can be reduced to a level corresponding to a temperature within the range required for accurate and/or reliable operation of temperature sensors 250. In some examples, power dissipation monitoring circuitry 213 and/or power management circuitry can cause host processor 210 to delay the performance of certain functions or operations to limit or interrupt power to components of system 200. As an example, host processor 210 can postpone operations (or modify operations for reduced power consumption) involving touch screen 220, GPS circuitry (not shown), wireless communication chips (not shown), antennas (not shown), or other components of system 200 that can be thermal aggressors, until after a measurement interval associated with temperature sensors 250 (e.g., an interval during which one or more of the components receives less power).

Additionally, or alternatively, characterizations of the components (e.g., a rise time, a fall time, and amplitude measured for each thermal aggressor at various respective power levels) can be used for temperature compensation. For example, host processor 210 can use temperature compensation models to adjust sensor measurements or sensor data according to the temperature within the device or the temperature contribution of thermal aggressors (e.g., heat-generating components of system 200). As an example, the amount of power draw by components of system 200 can be measured by power dissipation monitoring circuitry 213. The measured power draw can be used to correct for heat from thermal aggressors within the device. In some examples, the compensation can be applied when the power draw corresponds to a temperature change outside of a range required for accurate and/or reliable operation of temperature sensors 250. Accordingly, a temperature compensation model (e.g., the temperature change corresponding to the amount of power drawn by the components) can be used (e.g., by temperature sensor controller 240) to adjust sensor data from temperature sensors 250 to account for the elevated temperature within the device caused by thermal aggressors.

Computing system 200 can also include one or more input/output (I/O) controllers that can be operatively coupled to processor 210. I/O controllers can be configured to control interactions with one or more I/O devices (e.g., touch sensor panels, display screens, touch screens, physical buttons, dials, slider switches, joysticks, or keyboards). I/O controllers can operate by exchanging data between processor 210 and the I/O devices that desire to communicate with processor 210. The I/O devices and I/O controller can communicate through a data link. The data link can be a unidirectional or bidirectional link. In some cases, I/O devices can be connected to I/O controllers through wireless connections. A data link can, for example, correspond any wired or wireless connection including, but not limited to, PS/2, Universal Serial Bus (USB), Firewire, Thunderbolt, Wireless Direct, IR, RF, Wi-Fi, Bluetooth or the like.

Computing system 200 can include a temperature sensor controller 240 operatively coupled to processor 210 and to one or more temperature sensors 250. As described herein, in some examples, the temperature sensor controller 240 can be coupled to optical sensor controller 212. The temperature sensors 250 can include one or more temperature sensors 254, one or more heat flux sensors 256, and corresponding sensing circuitry 252 (e.g., analog and/or digital circuitry to measure signals at the sensors 254 and/or 256, provide processing (e.g., amplification, filtering, level-shifting), and convert analog signals to digital signals). As an example, the one or more temperature sensors 254 and one or more heat flux sensors 256 can be configured to measure temperature at various locations within system 200, including at least one location or region inside the wearable device different than a location or region in which a temperature sensor is disposed for system 200. These temperatures and/or heat flux measurements can be used to measure temperature characteristics of the device under various modes of operation (e.g., to estimate when temperatures within a device are approaching unsafe or unsustainable levels), to estimate temperatures outside the device, or to estimate a physiological signal associated with a user (e.g., a body temperature of the user). Measured raw data from the temperature sensors 254, heat flux sensors 256, and sensing circuitry 252 can be transferred to processor 210 (via temperature sensor controller 240), and processor 210 can perform the signal processing described herein to estimate internal or external temperatures and/or to estimate physiological signals (e.g., body temperature associated with the user). Processor 210 and/or temperature sensor controller 240 can operate temperature sensors 250 to measure temperature values associated with system 200, and to estimate temperature values associated with the environment external to the system. In some examples, temperature sensor controller 240 can include signal processor 242 to sample, filter, and/or convert (from analog to digital) signals generated by various temperature sensors 250, which can be positioned at different locations within a housing for system 200. Signal processor 242 can be a digital signal processing circuit such as a digital signal processor (DSP). The analog data measured by the temperature sensors 250 can be converted into digital data by an analog to digital converter (ADC). In some examples, and the digital data from the temperature sensors can be stored for processing in a buffer (e.g., a FIFO) or other volatile or non-volatile memory (not shown) in temperature sensor controller 240. In some examples, data from the temperature sensors are used as inputs to a heat model for the device and used to estimate temperatures external to the housing of system 200 (e.g., temperature of an object or user that contacts a portion of the device or an ambient temperature). In some examples, processor 210 and/or temperature sensor controller 240 can store the raw data and/or processed information in memory (e.g., ROM or RAM) for historical tracking or for future diagnostic purposes.

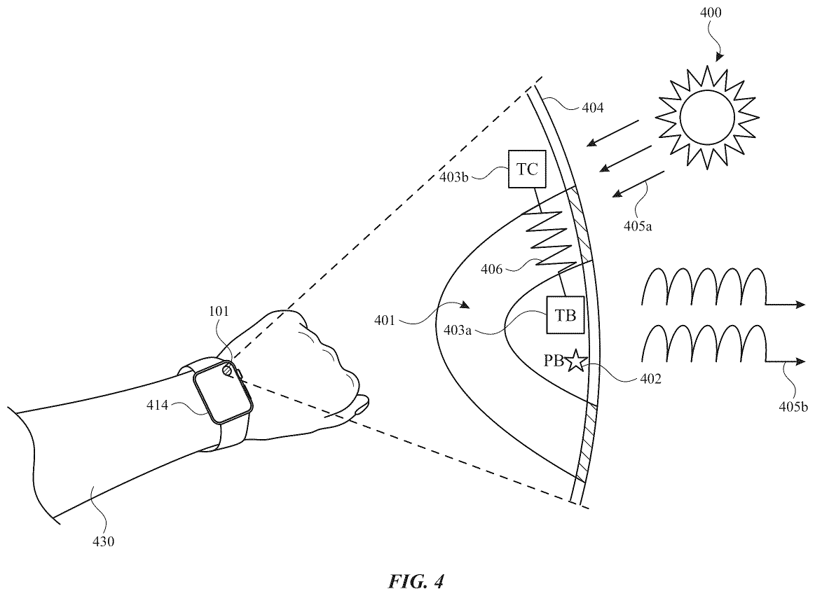

To accurately model the environment outside of system 200, in some examples, temperature sensors 254 and/or heat flux sensors 256 can be used in conjunction. In certain examples, temperature sensor controller 240 can use measurements from multiple separate temperature sensors 254, ideally located at well-characterized locations within the housing of system 200, to estimate heat flux through the device. In some examples, the heat flux within the housing of the system 200 is generated by an external heat source (e.g., a source of thermal energy beyond the housing of the system 200) and is used by the system 200 to estimate a temperature of the external heat source. In some examples, the external heat source corresponds to thermal energy (e.g., a biometric temperature) generated by a user of the system (e.g., user 430 discussed below with reference to FIG. 4). In some examples, the external heat source corresponds to an ambient temperature of an environment as discussed in further detail below. In some examples, temperature sensors can include a negative temperature coefficient (NTC) temperature sensor, a resistance temperature detector (RTD), or a diode-based temperature sensor. A heat flux sensor 256, such as a thermopile temperature sensor, includes multiple thermocouples coupled in series. Each thermocouple can include two (or more) different conductive materials, characterized by or otherwise associated with different respective Seebeck coefficients. A first end of a heat flux sensor 256 can include a first set of junctions between the two different conductive materials, and a second end of the heat flux sensor 256 can include a second set of junctions between the two different conductive materials. When these two ends of a heat flux sensor 256 can be positioned at respective first and second locations within system 200, the heat flux sensor 256 can generate a voltage signal proportional to a temperature gradient or a temperature difference between the first and second locations within system 200. When one end of a heat flux sensor 256 is positioned close to, or mechanically coupled to a location or region within a housing for system 200, temperature sensor controller 240 can use the temperature gradient generated by the heat flux sensor to estimate the temperature of objects that contact an outer surface location of system 200 that can correspond to where one end of the heat flux sensor 256 can be positioned inside the device.

Computing system 200 can include an optical sensor controller 212 operatively coupled to processor 210 and to one or more optical sensors 211. The optical sensor(s) can include light emitter(s) 204, light detector(s) 206 and corresponding sensing circuitry 208 (e.g., analog circuitry to drive emitters and measure signals at the detector, provide processing (e.g., amplification, filtering), and convert analog signals to digital signals). As an example, light emitters 204 and light detectors 206 can be configured to generate and emit light into a user's skin and detect returning light (e.g., reflected and/or scattered) to measure a physiological signal (e.g., a photoplethysmogram, or PPG signal). The absorption and/or return of light at different wavelengths can also be used to determine a characteristic of the user (e.g., oxygen saturation, heart rate) and/or about the contact condition between the light emitters 204/light detectors 206 and the user's skin. Measured raw data from the light emitters 204, light detectors 206 and sensing circuitry 208 can be transferred to processor 210, and processor 210 can perform the signal processing described herein to estimate a characteristic (e.g., oxygen saturation, heart rate, etc.) of the user from the physiological signals. Processor 210 and/or optical sensor controller 212 can operate light emitters 204, light detectors 206 and/or sensing circuitry 208 to measure data from the optical sensor. In some examples, optical sensor controller 212 can include timing generation for light emitters 204, light detectors 206 and/or signal processor 214 to sample, filter and/or convert (from analog to digital) signals measured from light at different wavelengths. Optical sensor controller 212 can process the data in signal processor 214 and report outputs (e.g., PPG signal, relative modulation ratio, perfusion index, heart rate, on-wrist/off-wrist state, etc.) to the processor 210. Signal processor 214 can be a digital signal processing circuit such as a digital signal processor (DSP). The analog data measured by the optical sensor(s) 211 can be converted into digital data by an analog to digital converter (ADC), and the digital data from the physiological signals can be stored for processing in a buffer (e.g., a FIFO) or other volatile or non-volatile memory (not shown) in optical sensor controller 212. In some examples, some light emitters and/or light detectors can be activated, while other light emitters and/or light detectors can be deactivated (by power management circuitry 209) to conserve power, for example, or for time-multiplexing (e.g., to avoid interference between channels). In some examples, processor 210 and/or optical sensor controller 212 can store the raw data and/or processed information in memory (e.g., ROM or RAM) for historical tracking or for future diagnostic purposes.

In some examples, some light emitters and/or light detectors have operation characteristics that vary based on the temperature of the light emitters and/or light detectors. As an example, some light emitters may output light at a wavelength that varies based on the temperature of the light emitter. In some examples, optical sensor controller 212 and/or processor 210 (higher power processor 211-2 and/or lower power processor 211-1) can receive temperature information associated with the light emitter (e.g., from temperature sensor controller 240), and adjust the wavelength of the optical sensor and/or processing of signals associated with the light emitter and/or a corresponding light detector based on the received temperature information. For example, an estimation of a physiological characteristic (e.g., oxygen saturation, heart rate) may be sensitive to wavelengths of light used to measure optical signals. In some examples, the optical sensor controller 212 and/or processor 210 can use the received temperature information to estimate a wavelength of light generated by the optical sensor and compensate the estimation of the physiological characteristic based on the estimated wavelength of light.

Computing system 200 can also include one or more motion and/or orientation sensors 230, such as an accelerometer, a gyroscope, an inertia-measurement unit (IMU), etc. In some examples, the motion and/or orientation sensors 230 can include a multi-channel accelerometer (e.g., a 3-axis accelerometer).

Computing system 200 can also include, in some examples, a touch and display controller 216 operatively coupled to processor 210 and to touch screen 220. Touch screen 220 can be configured to display visual output in a graphical user interface (GUI), for example. The visual output can include text, graphics, video, and any combination thereof. In some examples, the visual output can include a text or graphical representation of the physiological signal (e.g., a PPG waveform) or a characteristic of the physiological signal (e.g., oxygen saturation, heart rate, etc.) Touch screen can be any type of display including a liquid crystal display (LCD), a light emitting polymer display (LPD), an electroluminescent display (ELD), a field emission display (FED), a light emitting diode (LED) display, an organic light emitting diode (OLED) display, or the like. Processor 210 can send raw display data to touch and display controller 216, and touch and display controller 216 can send signals to touch screen 220. Data can include voltage levels for a plurality of display pixels in touch screen 220 to project an image. In some examples, processor 210 can be configured to process the raw data and send the signals to touch screen 220 directly. Touch and display controller 216 can also detect and track touches or near touches (and any movement or release of the touch) on touch screen 220. For example, touch processor 218 can process data representative of touch or near touches on touch screen 220 (e.g., location and magnitude) and identify touch or proximity gestures (e.g., tap, double tap, swipe, pinch, reverse-pinch, etc.). Processor 210 can convert the detected touch input/gestures into interaction with graphical objects, such as one or more user-interface objects, displayed on touch screen 220 or perform other functions (e.g., to initiate a wake of the device or power on one or more components).

In some examples, touch and display controller 216 can be configured to send raw touch data to processor 210, and processor 210 can process the raw touch data. In some examples, touch and display controller 216 can process raw touch data itself (e.g., in touch processor 218). The processed touch data (touch input) can be transferred from touch processor 218 to processor 210 to perform the function corresponding to the touch input. In some examples, a separate touch sensor panel and display screen can be used, rather than a touch screen, with corresponding touch controller and display controller.

In some examples, the touch sensing of touch screen 220 can be provided by capacitive touch sensing circuitry (e.g., based on mutual capacitance and/or self-capacitance). For example, touch screen 220 can include touch electrodes arranged as a matrix of small, individual plates of conductive material or as drive lines and sense lines, or in another pattern. The electrodes can be formed from a transparent conductive medium such as ITO or ATO, although other partially or fully transparent and non-transparent materials (e.g., copper) can also be used. In some examples, the electrodes can be formed from other materials including conductive polymers, metal mesh, graphene, nanowires (e.g., silver nanowires) or nanotubes (e.g., carbon nanotubes). The electrodes can be configurable for mutual capacitance or self-capacitance sensing or a combination of mutual and self-capacitance sensing. For example, in one mode of operation, electrodes can be configured to sense mutual capacitance between electrodes; in a different mode of operation, electrodes can be configured to sense self-capacitance of electrodes. During self-capacitance operation, a touch electrode can be stimulated with an AC waveform, and the self-capacitance to ground of the touch electrode can be measured. As an object approaches the touch electrode, the self-capacitance to ground of the touch electrode can change (e.g., increase). This change in the self-capacitance of the touch electrode can be detected and measured by the touch sensing system to determine the positions of one or more objects when they touch, or come in proximity to without touching, the touch screen. During mutual capacitance operation, a first touch electrode can be stimulated with an AC waveform, and the mutual capacitance between the first touch electrode and a second touch electrode can be measured. As an object approaches the overlapping or adjacent region of the first and second touch electrodes, the mutual capacitance therebetween can change (e.g., decrease). This change in the mutual capacitance can be detected and measured by the touch sensing system to determine the positions of one or more objects when they touch, or come in proximity to without touching, the touch screen. In some examples, some of the electrodes can be configured to sense mutual capacitance therebetween and some of the electrodes can be configured to sense self-capacitance thereof.

Note that one or more of the functions described herein, including estimating a temperature internal or external to an electronic device according to some examples of the disclosure, can be performed by firmware stored in memory (or in program storage 202) and executed by temperature sensor controller 240, optical sensor controller 212, touch and display controller 216 or processor 210. The firmware can also be stored and/or transported within any non-transitory computer-readable storage medium for use by or in connection with an instruction execution system, apparatus, or device, such as a computer-based system, processor-containing system, or other system that can fetch the instructions from the instruction execution system, apparatus, or device and execute the instructions. In the context of this document, a “non-transitory computer-readable storage medium” can be any medium (excluding signals) that can contain or store the program for use by or in connection with the instruction execution system, apparatus, or device. The computer-readable storage medium can include, but is not limited to, an electronic, magnetic, optical, electromagnetic, infrared, or semiconductor system, apparatus or device, a portable computer diskette (magnetic), a random access memory (RAM) (magnetic), a read-only memory (ROM) (magnetic), an erasable programmable read-only memory (EPROM) (magnetic), a portable optical disc such a CD, CD-R, CD-RW, DVD, DVD-R, or DVD-RW, or flash memory such as compact flash cards, secured digital cards, USB memory devices, memory sticks, and the like.

The firmware can also be propagated within any transport medium for use by or in connection with an instruction execution system, apparatus, or device, such as a computer-based system, processor-containing system, or other system that can fetch the instructions from the instruction execution system, apparatus, or device and execute the instructions. In the context of this document, a “transport medium” can be any medium that can communicate, propagate or transport the program for use by or in connection with the instruction execution system, apparatus, or device. The transport medium can include, but is not limited to, an electronic, magnetic, optical, electromagnetic or infrared wired or wireless propagation medium.

FIG. 3 illustrates an example configuration of the temperature sensing device 101 discussed above with reference to FIGS. 1A-1K (hereon labeled as temperature sensing device 300) disposed at a wearable device 314 according to some examples of this disclosure. In some examples, as discussed above with reference to FIGS. 1A-1K, the temperature sensing device 101 is configured to calculate a temperature of an environment such as an ambient temperature. In some examples, the wearable device 314 is placed within an environment including one or more characteristics of the environment(s) discussed below with reference to FIGS. 4-7. In some examples, the ambient temperature calculated is a temperature of the surrounding environment or air in which a user and/or system operates, such as the wearable device 314 shown in FIG. 3. Optionally measured in degrees Celsius (° C.) or Fahrenheit (° F.), the ambient temperature optionally serves as the baseline for physical and biological processes, influencing thermodynamic equilibrium, heat transfer, and system performance.

In some examples, the wearable device 314 includes one or more characteristics of the watch 102 as illustrated above by FIG. 1B. For example, as shown in FIG. 3, the wearable device 314 optionally includes a first control 314c and a second control 314d (optionally related to the controls displayed on the edges of the watch 102 illustrated in FIG. 1B), optionally configured to alter various operations at the wearable device 314 such as the temperature sensing device 101. For example, the temperature sensing device 101 optionally receives an input signal generated in response to a user of the wearable device 314 optionally interacting with the first control 314c, the second control 314d and/or a display component 314e (e.g., a bezel). In some examples, the first control 314c, the second control 314d, and/or the display component 314e are configured to activate and/or deactivate the temperature sensing device 101 in response to the user of the wearable device 314 optionally interacting with the aforementioned controls. In some examples, the temperature sensing device is active independent of inputs detected at the first control 314c, the second control 314d and/or the display component 314c. In some examples, the temperature sensing device 101 is included at any of the electronic devices as illustrated by FIGS. 1A-1K. In some examples, as shown in FIG. 3, the wearable device 314 includes watchband 314b disposed on opposing sides of bezel 314e. In some examples, the bezel 314e encloses a perimeter of the display component 314a. In some examples, the temperature sensing device 101 is disposed beneath a corner of the display component 314a (illustrated with a hashed circle as shown in FIG. 3, indicating an embedded device). In some examples, the temperature sensing device 101 is embedded beneath the display component 314a and configured to calculate an temperature associated with a thermal energy source outside the wearable device 314.

In some examples, the temperature sensing device 101, as illustrated by the top-down view 300, comprises a plurality of concentric volumes containing a first temperature sensor 303b, a second temperature sensor 303a, and a heating element 302. In some examples, the concentric volumes illustrated by the top-down view 300 correspond to concentric hemispheres (shown below in FIGS. 4 through 7) extending into the internal volume of the wearable device 314.

In some examples, insulator 301 thermally isolates the second temperature sensor 303a and the heating element 302 from the first temperature sensor 303b and the wearable device 314. In some examples, the insulator 301 is further characterized as a hemisphere containing the second temperature sensor 303a extending downward into the housing of the wearable device 314 as discussed below with reference to FIG. 4. In some examples, the insulator 301 is a hemisphere corresponding to the concentric hemispheres as discussed above. In some examples, the insulator 301 includes a base (e.g., a base of the hemisphere) disposed on an underside of the display component 314a.

In some examples, (not shown) the second temperature sensor 303a and the heating element 302 are suspended within a substance with high thermal conductance and low capacitance (e.g., a putty) and encapsulated by the insulator 301, allowing the free flow of thermal energy between the second temperature sensor 303a and the heating element 302. Additionally or alternatively, in some examples, the second temperature sensor 303a and the heating element 302 are thermally coupled via a thermally conductive wire disposed in the insulator 301 (not shown). In some examples, the temperature of the environment, discussed above, is calculated based on a power output of the heating element 302 discussed in further detail below with reference to method 800.

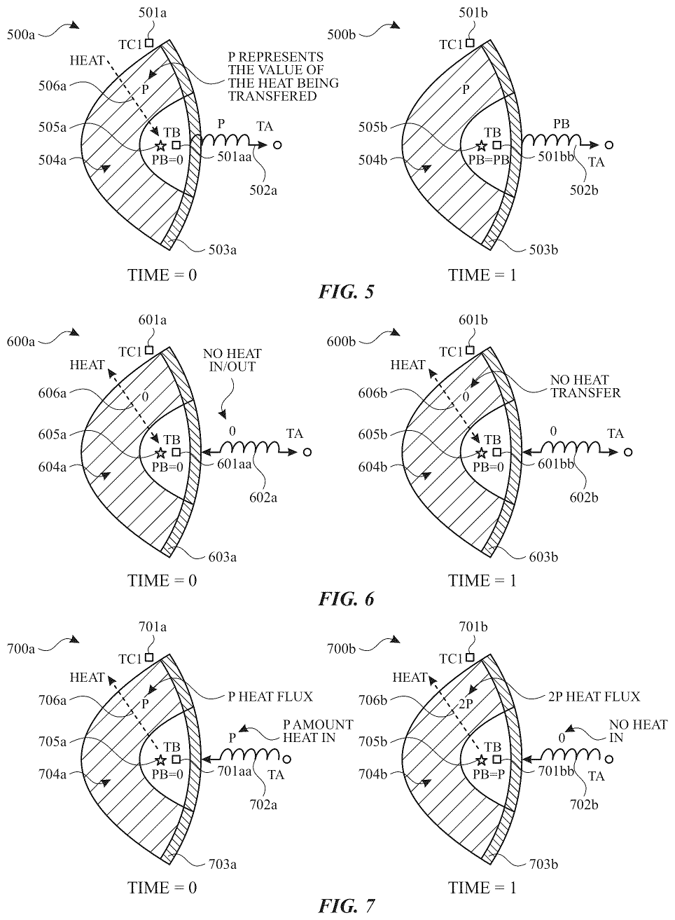

In some examples, the temperature sensing device 101 detects, via the first temperature sensor 303b and the second temperature sensor 303a, a heat flux across the insulator 301. In this example, the temperature sensing device 101 optionally determines a direction of the heat flux and optionally initiates the heating element 302 in response to the direction of the heat flux. In some examples, the heat flux is directed from the first temperature sensor 303b to the second temperature sensor 303a. In some examples, the heat flux is directed from the second temperature sensor 303b to the first temperature sensor 303a. In some examples, the temperature sensing device 101 calculates the sensed temperature based on a predetermined method corresponding to the direction of the heat flux as discussed in further detail below with reference to FIGS. 5 through 7. In some examples, the heat flux is determined based on a temperature gradient between the first temperature sensor 303b and the second temperature sensor 303a (e.g., a difference in calculated temperature at the first temperature sensor 303b and the second temperature sensor 303a). The first temperature sensor 303b senses a temperature that is based on a combination of the thermal energy absorbed/emitted from the environment, the thermal energy within the wearable device 314, and the thermal energy absorbed by a user of the wearable device 314 (see FIG. 4, user 430), for example. The second temperature sensor 303a senses a temperature that is based on thermal energy absorbed/emitted from the environment and the thermal energy absorbed by the thermal energy emitted by the heating clement 302.

In some examples, the heating element 302 is a resistive heating element configured to generate thermal energy in response to the heat flux detected above. Typically composed of materials like nichrome, ceramic, or other conductive alloys, the resistive heating element (e.g., heating element 302) converts electrical energy into thermal energy when an electric current passes through. In some examples, the heating element 302 outputs the thermal energy in proportion to the power level as discussed above. In some examples, the temperature sensing device 101 initiates the heating clement 302 according to the heat flux described above.

FIG. 4 illustrates an example configuration of the temperature sensing device 101 disposed at a wearable device 414 at a user 430 according to some examples of this disclosure. In some examples, the temperature sensing device 101 is disposed at a position within the wearable device 414 not adjacent to the surface of user 430 (e.g., skin). In some examples, the components of the temperature sensing device 101 described herein with reference to FIG. 4 include one or more characteristics of the component of the temperature sensing device 101 discussed above with reference to FIG. 3. For example, insulator 401, shown by cross-sectional view 410, is optionally the same insulator as insulator 301 illustrated above by FIG. 3. In some examples, the wearable device 414, including temperature sensing device 101, is exposed to an environment including sun 400. In some examples, the temperature sensing device 101 includes a first temperature sensor 403b, and a second temperature sensor 403a disposed beneath a substrate 404. For example, the first temperature sensing device 403b and the second temperature sensing device 403b are optionally disposed beneath a touch sensing display (e.g., substrate 404) including one or more characteristics of display component 314a discussed above with reference to FIG. 3. In some examples, the substrate 404 is a component of a touch screen stack-up (e.g., cover material or cover glass) including display components (e.g., including light emitting diodes and/or display driving circuitry), touch components (e.g., including touch electrodes and touch detection circuitry), and the force and shield components (e.g., force and/or shield electrodes, force detection circuitry, and/or shield driving circuitry). In some examples, as illustrated by the wearable device 414, the substrate optionally corresponds to a display of an electronic device (e.g., display component 314a). In some examples, the second temperature sensing device 403a and a heating element 402 are encapsulated within the insulator 401. In some examples, the configuration of the second temperature sensing device 403a and the heating element 402 as illustrated by the cross-sectional view 410 includes one or more characteristics of the configuration of the second temperature sensing device 403a and the heating element 302 as illustrated by the top-down view 300 shown in FIG. 3. In some embodiments, the temperature sensing device is disposed beneath a portion of the device housing other than the display, such as a bezel of the device. Optionally, the device housing and/or bezel includes metal (e.g., aluminum, stainless steel, or titanium), plastic, and/or glass.

In some examples, as illustrated in FIG. 4, the first temperature sensor 403b and the second temperature sensor 403a are disposed beneath the substrate 404. The thermal resistance between the environment and the first temperature sensor 403b is optionally substantially equal to the thermal resistance between the environment and the second temperature sensor 403a. For example, the first temperature sensor 403b and the second temperature sensor 403a are disposed an equal distance beneath substrate 404. In some examples, the first temperature sensor 403b and the second temperature sensor 403a are separated from each other by the insulator 401 (also below substrate 404) with a thermal resistance 406, as shown by the cross-sectional view 410. In some examples, substrate 404 includes a distinct thermal resistance as compared to insulator 401. To accurately assess the sensed temperature, temperature sensors (e.g., first temperature sensor 403b and second temperature sensor 403a) of equal depth are disposed beneath a surface of an electronic device, as shown in the cross-sectional view 410. In this configuration, the first temperature sensor 403b and the second temperature sensor 403a receive/absorb an equal amount of solar thermal energy emitted by sun 400 as illustrated by thermal radiation 405a, while second temperature sensor 403a remains thermally isolated from thermal energy within the wearable device 414 (not shown) by insulator 401. Accordingly, the effect of thermal radiation 405a is negated in the temperature sensing device 101 calculation of the sensed temperature via the detection of the heat flux between the first temperature sensor 403b and the second temperature sensor 403a.

In some examples, the heat flux between the first temperature sensor 403b and the second temperature sensor 403a are thermally connected across the insulator 401 with the thermal resistance 406. In some examples, the insulator 401 transfers the above discussed heat flux from the first temperature sensor 403b to the second temperature sensor 403a according to a release of thermal energy 405b into the environment including sun 400.

Thermal energy 405b, as illustrated by FIG. 4, represents a transfer of thermal energy between the temperature sensing device 101 to the environment. In some examples, the transfer of the thermal energy between the temperature sensing device 101 includes an absorption of thermal energy from the environment to the temperature sensing device 101 (shown by the arrow direction of thermal radiation 405a). For example, the environment optionally includes the sun 400 emitting thermal radiation 405a. As illustrated by the cross-sectional view 410, the arrows representing thermal radiation 405a illustrate the sun 400 transferring thermal energy from the environment to the temperature sensing device 100. In some examples, the thermal radiation 405a is emitted by a heat source not illustrated in FIG. 4. For example, thermal radiation 405a is optionally generated/emitted by an artificial source such as an electric heater (not illustrated). In some examples, thermal energy 405b corresponds to radiative energy emitted from the temperature sensing device 101. In some examples, as illustrated by FIG. 4, if the sensed temperature is lower than an internal temperature of the temperature sensing device 101, the first temperature sensor 403b transfers thermal energy (e.g., the heat flux) to the second temperature sensor 403a across the insulator 401. As the second temperature sensor 403a absorbs the incoming heat flux, the second temperature sensor 403a emits thermal energy 405b to the environment across substrate 404. In some examples, second temperature sensor 403a transfers thermal energy 405b to substrate 404, which in turn, emits thermal energy 405b to the environment.

FIGS. 5-7 illustrates examples of a first heat flux at the temperature sensing device at a first time and a second heat flux at the temperature sensing device at a second time according to some examples of the disclosure.

FIG. 5 illustrates an example calculation of a temperature associated with an external heat source having a temperature lower than an initial temperature of a first temperature sensor 501b (e.g., “TC1”) across a time step at a temperature sensing device including one or more characteristics of the temperature sensing device 101 discussed above. In some examples, the temperature associated with the environment is an ambient temperature of an environment. In some examples, at a first time (e.g., Time=0), as illustrated by cross-sectional view 500, a heat flux 506 (e.g., labeled “P”) flows from the first temperature sensor 501b to a second temperature sensor 501a (e.g., “TB”) across insulator 504. At the first time, while the heat flux 506 flows across insulator 504, a heating element 505 is configured to release no thermal energy (e.g., label “PB=0”) to the second temperature sensor 501a. In some examples, heat flux 506 is absorbed by the second temperature sensor 501a and radiated across substrate 503 to the environment (e.g., “TA”) via thermal emission 502.

At a second time (e.g., Time=1), as illustrated by the cross-sectional view 500, the heating element 505 is heated to a temperature (e.g., label “PB=PB”) such that a heat flux is no longer detected by the temperature sensing device across insulator 504b. In some examples, the heating element 505 is configured at a temperature such that the thermal energy transferred to the second temperature sensor 501a is equal to the heat flux 506 at Time=0. In some examples, between Time=0 and Time=1, the temperature sensing device periodically samples the respective temperatures of the first temperature sensor 501b and the second temperature sensor 501a to determine if the heat flux 506a is a non-zero value. In the event the heat flux 506 is detected (i.e., flowing the from first temperature sensor 501b to the second temperature sensor 501a), the heating element 505 is configured to increase a power level of the heating element 505, resulting in an increased thermal energy output. In some examples, at Time=1, the thermal energy output by the heating element 505 is radiated out across substrate 503 as thermal emission 502. In some examples, at Time=1, the external heat source temperature is calculated as Ta=(Tb,1·(Tb,2+Pb,2·R)−Tb,2 ·Tc)/(Tb,1−Tc+Pb,2·R) according to the following table of values:

| | | | |
|---|---|---|---|
| Ta | Temperature | Tc | First |
| | External | | temperature |
| | Heat Source | | sensor |
| | | | 501a/501b |
| Tb, 1 | Second | R | Thermal |
| | temperature | | resistance of |
| | sensor 501b | | Insulator |
| | | | 504 |
| Tb, 2 | Second | Pb, 2 | Temperature |
| | temperature | | of heating |
| | sensor 501a | | element 505 |
| | at T = 1 | | at T = 1 |

FIG. 6 illustrates an example calculation of a sensed temperature associated with an external heat source equal to an initial temperature of a first temperature sensor 601b across a time step at a temperature sensing device including one or more characteristics of the temperature sensing device 101 discussed above. In some examples, the sensed temperature associated with the external heat source is an ambient temperature of an environment. In some examples, as illustrated by FIG. 6, a heat flux 606 is bidirectional across insulator 604, demonstrating an equalized temperature balance between the internal temperature of the temperature sensing device and the environment. In some examples, at Time=0, as discussed above with reference to FIG. 5, heating element 605 is configured at a zero power level outputting no thermal energy as a response to the bidirectional heat flux across insulator 604. In some examples, as illustrated by cross-sectional view 600, a thermal emission 602 is represented as bidirectional (e.g., see double sided arrow) across substrate 603. In some examples, in accordance with a determination of a bidirectional heat flux (e.g., no detected heat flow between the first temperature sensor 601b and the second temperature sensor 601a), the temperature sensing device approximates the sensed temperature to the temperature of the first temperature sensor 601b and/or second temperature sensor 601a.

FIG. 7 illustrates an example calculation of a sensed temperature associated with an external heat source that is greater than an initial temperature of a first sensor 701b across a time step at a temperature sensing device including one or more characteristics of the temperature sensing device 101 discussed above. In some examples, the sensed temperature associated with the external heat source is an ambient temperature of an environment. In some examples, as illustrated by cross-sectional view 700, a heat flux 706 flows from the second temperature sensor 701a to the first temperature sensor 701b across insulator 704. At the first time, while the heat flux 706 flows across insulator 704, a heating element 705 is configured to release no thermal energy (e.g., label “PB=0”) to the second temperature sensor 701a. In some examples, thermal energy of heat flux 706 is absorbed by the first temperature sensor 701b. In some examples, the environment transfers thermal energy via thermal emission 702 to the second temperature sensor 701aa across substrate 703. In some examples, the thermal emission 702a carries a thermal energy of “P”, as illustrated by the cross-sectional view 700.

At a second time (time=1), as illustrated by the cross-sectional view 700, the heating clement 705 is heated to a temperature (e.g., label “PB=P”) such that a heat flux 706a, larger than the heat flux 706b, is detected by the temperature sensing device across insulator 704. In some examples, the heating element 705 is configured to release an amount of thermal energy such that the heat flux 706b across the insulator 704 is equivalent to “2P”. In some examples, the heating element 705 releases an amount of thermal energy equal to the thermal emission 702 (e.g., Label=“P”) absorbed across substrate 703, resulting at Time=1 such that substrate 703 absorbs no thermal emission from the environment (e.g., thermal emission 702 with Label=0). In the event that the substrate 703 no longer absorbs thermal energy from the environment as a result of the heating element 705 being heated to temperature “P” the temperature sensing device calculates the sensed temperature as equivalent to a temperature of second temperature sensor 701a at Time=1. In some examples, the substrate 703 is assumed to be approximate to a blackbody, such that a heat flux across the substrate 703 is equal to the thermal emission 702.

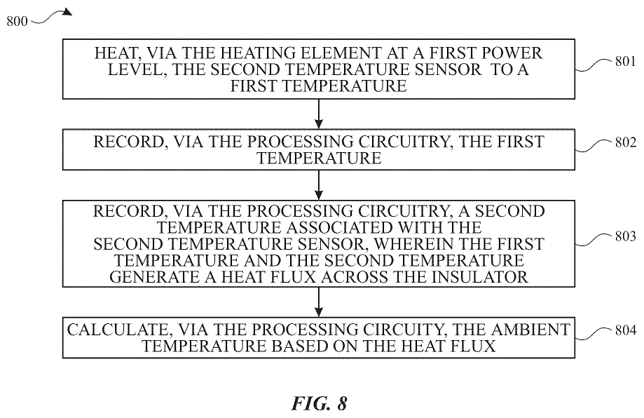

FIG. 8 is a flow diagram illustrating a method 800 of calculating a temperature measurement associated with an environment, such as the environment including the sun 400 discussed above or a different physical environment, according to some examples of this disclosure. The method is optionally performed at any of the electronic devices described above with reference to FIG. 1 (e.g., the watch 102). In some examples, performing the method includes executing instructions stored using a non-transitory computer readable storage medium at an electronic device with one or more processors. Some operations in the method 800 are, optionally, combined and/or the order of some operations, is optionally changed. In some examples, the method 800 comprises four steps (e.g., blocks 801 through 804).

In some examples, block 801, in accordance with the method 800, involves heating a second temperature sensor within a temperature sensing device (e.g., the temperature sensing device 101 as shown in FIG. 3), to a first temperature according to some examples of this disclosure. In some examples, the second temperature sensor corresponds to the second temperature sensor 403a with reference to FIG. 4 as discussed above. In some examples, the heating step is facilitated through the heating element 402 as discussed above with reference to FIG. 4. In some examples, the heating element (such as heating element 402) heats the second temperature sensor to the first temperature over a time period.

In some examples, block 802, in accordance with the method 800, involves recording the first temperature at the first temperature sensor according to some examples of this disclosure. In some examples, the first temperature sensor corresponds to the first temperature sensor 303b with reference to FIG. 3, the first temperature sensor 403b with reference to FIG. 4, the first temperature sensor 501b with reference to FIG. 5, the first temperature sensor 601b with reference to FIG. 6, and/or the first temperature sensor 701b with reference to FIG. 7 as discussed above. In some examples, the first temperature recording is implemented by processing circuitry at the temperature sensing device (not shown). In some examples, the first temperature sensor records the first temperature after the time period (see block 801) has elapsed. In some examples, the processing circuitry implements recording the first temperature concurrently with recording the second temperature discussed in further detail below with reference to block 803.

In some examples, block 803, in accordance with the method 800, involves recording of a second temperature by a second temperature sensor (e.g., second temperature sensor 403a in FIG. 4), different than the first temperature sensor. In some examples, the recording step is implemented during the above heating step associated with block 801 and/or the recording step associated with block 802. In some examples, the first temperature is recorded by a second temperature sensor (e.g., second temperature sensor 303b and/or second temperature sensor 403b). In some examples, the heat flux between the first temperature sensor and the second temperature is across an insulator (e.g., insulator 401 of FIG. 4) of the temperature sensing device during the time period. In some examples, the heat flux is an instantaneous heat flux at the time of recording. In some examples, the heat flux is an average of temperature(s) recorded during blocks 801 and 802 during the time period. In some examples, the heat flux is directional towards the first temperature sensor (e.g., heat flux 706 of FIG. 7). In some examples, the heat flux is directional towards the second temperature sensor (e.g., heat flux 506 of FIG. 5). In some examples, the heat flux is bidirectional, indicating that the first temperature is equal to the second temperature (e.g., heat flux 606 of FIG. 6).

In some examples, block 804, in accordance with the method 800, the processing circuitry calculates the temperature based on the above discussed heat flux according to some examples of this disclosure. In some examples, the temperature is calculated after the time period, discussed above with reference to block 801, has elapsed. In some examples, the heat flux is determined via a multi-step process according to methods illustrated above with reference to FIGS. 5-7. In some examples, the heat flux is a zero value (as discussed above), indicating the first and/or second temperature is equal to the temperature.

It should be understood that the particular order in which the blocks of the flowchart of FIG. 8 have been described is merely exemplary and is not indented to indicate that the described order is the only order in which the operations could be performed. One of ordinary skill in the art would recognize various ways to reorder the operations describe herein.

Therefore, according to the above, some examples of the disclosure are directed to an electronic device comprising a housing that includes an exterior surface of the electronic device; a first temperature sensor thermally connected to an interior of the device and thermally connected to the housing at a first location of the housing; a second temperature sensor thermally isolated from the first temperature sensor and the interior of the device by an insulator, wherein the second temperature sensor is thermally connected to the housing at a second location of the housing, different than the first location of the housing; a heating element located proximate to the second temperature sensor, wherein the heating element is thermally isolated from the first temperature sensor and the interior of the device by the insulator; and processing circuity configured to implement a method of measuring a temperature external to the housing comprising: heating, via the heating element at a first power level, the second temperature sensor to a first temperature; recording, via the processing circuitry, the first temperature; recording, via the processing circuitry, a second temperature associated with the second temperature sensor, wherein the first temperature and the second temperature generate a heat flux across the insulator; and calculating, via the processing circuity, the temperature based on the heat flux. Additionally or alternatively, in some examples, the method of measuring the temperature external to the housing further comprises: at a first time: recording, via the processing circuitry, a temperature associated with the first temperature sensor; recording, via the processing circuitry, a temperature associated with the second temperature sensor; at a second time after the first time: heating the heating element to a first heating temperature using the first power level; and recording, via the processing circuitry, a temperature associated with the second temperature sensor. Additionally or alternatively, in some examples, the method of measuring the temperature external to the housing includes in accordance with a determination that the temperature associated with the first temperature sensor at the first time and the temperature associated with the second temperature sensor at the second time does not generate the heat flux across the insulator: calculating, via the processing circuity, the temperature external to the housing based at least on the first power level; in accordance with a determination that the temperature associated with the first temperature sensor at the first time and the temperature associated with the second temperature sensor at the second time generates the heat flux across the insulator: increasing from the first power level to a second power level at the heating element, wherein the second power level heats the heating element to a second heating temperature using the second power level, wherein the heating element at the second power level heats the second temperature sensor to an updated temperature; and in accordance with a determination that the temperature associated with the first temperature sensor at the first time and the updated temperature associated with the second temperature sensor does not generate the heat flux across the insulator: calculating, via the processing circuitry, the temperature external to the housing based at least on the second power level. Additionally or alternatively, in some examples, the method of measuring the temperature external to the housing further comprises in accordance with a determination that the heat flux across the insulator is zero at the first time, outputting, via the processing circuitry, the temperature external to the housing as the first temperature associated with the second temperature sensor. Additionally or alternatively, in some examples, the method of measuring the temperature external to the housing further comprises, in accordance with a determination that the heat flux across the insulator is zero at the second time, outputting, via the processing circuitry, the temperature external to the housing as the second temperature associated with the second temperature sensor. Additionally or alternatively, in some examples the first location and the second location are each disposed beneath the exterior surface of the device; and the first temperature sensor exchanges a first amount of thermal energy with the exterior surface of the device across the housing, wherein the second temperature sensor exchanges a second amount of thermal energy, substantially equal to the first amount of thermal energy, with the exterior surface of the device across the housing. Additionally or alternatively, in some examples the second temperature sensor further exchanges the second amount of thermal energy with an environment outside the housing of the device via the exterior surface of the device; and the second temperature sensor is thermally isolated from the interior of the device by the insulator. Additionally or alternatively, in some examples the insulator forms a dome having a base that is coupled to the housing at the second location of the housing, the insulator and housing at least partially surrounding the heating element and the second temperature. Additionally or alternatively, in some examples the base of the dome and a body of the dome at least partially surround an internal volume including the heating element and the second temperature sensor, wherein a portion of the internal volume is not occupied by the heating element, and the second temperature sensor includes a thermally conductive material. Additionally or alternatively, in some examples the device is configured to be wearable by a user of the electronic device. Additionally or alternatively, in some examples the device is configured to attach to the user such that the first location of the housing of the device and the second location of the housing of the device are not in contact with the user of the device while the device is attached to the user. Additionally or alternatively, in some examples the temperature external to the housing corresponds to a biometric temperature of the user. Additionally or alternatively, in some examples the processing circuitry is further configured to: detect a first input; and in response to the first input, initiate the method of measuring the temperature external to the housing during a detection period. Additionally or alternatively, in some examples the method of measuring the temperature external to the housing further includes: automatically recording the second temperature at predetermined time intervals. Additionally or alternatively, in some examples the temperature external to the housing corresponds to an ambient temperature associated with an environment encapsulating the device.

Some examples of the disclosure are directed to a method of measuring a temperature external to housing of an electronic device comprising: at the electronic device, wherein the electronic device includes at least a heating element, processing circuitry, an insulator, a first temperature sensor at a first location, and a second temperature sensor at a second location: heating, via the heating element at a first power level, the second temperature sensor to a first temperature; recording, via processing circuitry, the first temperature; recording, via the processing circuitry, a second temperature associated with the second temperature sensor, wherein the first temperature and the second temperature generate a heat flux across the insulator; and calculating, via the processing circuity, the temperature external to the housing based on the heat flux. Additionally or alternatively, in some examples the method includes at a first time: recording, via the processing circuitry, a temperature associated with the first temperature sensor; recording, via the processing circuitry, a temperature associated with the second temperature sensor; at a second time after the first time: heating the heating element to a first heating temperature using the first power level; and recording, via the processing circuitry, a temperature associated with the second temperature sensor. Additionally or alternatively, in some examples, the method further includes in accordance with a determination that the temperature associated with the first temperature sensor at the first time and the temperature associated with the second temperature sensor at the second time does not generate the heat flux across the insulator: calculating, via the processing circuity, the temperature external to the housing based at least on the first power level; in accordance with a determination that the temperature associated with the first temperature sensor at the first time and the temperature associated with the second temperature sensor at the second time generates the heat flux across the insulator: increasing from the first power level to a second power level at the heating element, wherein the second power level heats the heating element to a second heating temperature using the second power level, wherein the heating element at the second power level heats the second temperature sensor to an updated temperature; and in accordance with a determination that the temperature associated with the first temperature sensor at the first time and the updated temperature associated with the second temperature sensor does not generate the heat flux across the insulator: calculating, via the processing circuitry, the temperature external to the housing based at least on the second power level. Additionally or alternatively, in some examples, the method further includes in accordance with a determination that the heat flux across the insulator is zero at the first time, output, via the processing circuitry, the temperature external to the housing as the first temperature associated with the second temperature sensor. Additionally or alternatively, in some examples, the method further includes in accordance with a determination that the heat flux across the insulator is zero at the second time, output, via the processing circuitry, the temperature external to the housing as the second temperature associated with the second temperature sensor. Additionally or alternatively, in some examples the first location and the second location are each disposed beneath the exterior surface of the device; and the first temperature sensor exchanges a first amount of thermal energy with the exterior surface of the device across the housing, wherein the second temperature sensor exchanges a second amount of thermal energy, substantially equal to the first amount of thermal energy, with the exterior surface of the device across the housing. Additionally or alternatively, in some examples the second temperature sensor further exchanges the second amount of thermal energy with an environment outside the housing of the device via the exterior surface of the device; and the second temperature sensor is thermally isolated from the interior of the device by the insulator. Additionally or alternatively, in some examples the insulator forms a dome having a base that is coupled to the housing at the second location of the housing, the insulator and housing at least partially surrounding the heating element and the second temperature. Additionally or alternatively, in some examples the base of the dome and a body of the dome at least partially surround an internal volume including the heating clement and the second temperature sensor, wherein a portion of the internal volume is not occupied by the heating element, and the second temperature sensor includes a thermally conductive material. Additionally or alternatively, in some examples the device is configured to attach to be wearable by a user of the device. Additionally or alternatively, in some examples the device is configured to attach to the user such that the first location of the housing of the device and the second location of the housing of the device are not in contact with the user of the device while the device is attached to the user. Additionally or alternatively, in some examples the temperature external to the housing corresponds to a biometric temperature of the user. Additionally or alternatively, in some examples the processing circuitry is further configured to detect a first input; and in response to the first input, initiate the method of measuring the temperature external to the housing during a detection period. Additionally or alternatively, in some examples the method includes automatically recording the second temperature at predetermined time intervals. Additionally or alternatively, in some examples the temperature external to the housing corresponds to an ambient temperature associated with an environment encapsulating the device.

Some examples of the disclosure are directed to a non-transitory computer readable storage medium storing one or more programs, the one or more programs comprising instructions, which when executed by one or more processors of an electronic device, cause the electronic device to perform one or more of the methods described herein.

Although the disclosed examples have been fully described with reference to the accompanying drawings, it is to be noted that various changes and modifications will become apparent to those skilled in the art. Such changes and modifications are to be understood as being included within the scope of the disclosed examples as defined by the appended claims.

What is claimed is:

1. An electronic device comprising:
a housing that includes an exterior surface of the electronic device;
a first temperature sensor thermally connected to an interior of the device and thermally connected to the housing at a first location of the housing;
a second temperature sensor thermally isolated from the first temperature sensor and the interior of the device by an insulator, wherein the second temperature sensor is thermally connected to the housing at a second location of the housing, different than the first location of the housing;
a heating element located proximate to the second temperature sensor, wherein the heating element is thermally isolated from the first temperature sensor and the interior of the device by the insulator; and
processing circuity configured to implement a method of measuring a temperature external to the housing comprising:
heating, via the heating element at a first power level, the second temperature sensor to a first temperature;
recording, via the processing circuitry, the first temperature;
recording, via the processing circuitry, a second temperature associated with the second temperature sensor, wherein the first temperature and the second temperature generate a heat flux across the insulator; and
calculating, via the processing circuity, the temperature based on the heat flux.

2. The device of claim 1, wherein the method of measuring the temperature external to the housing further comprises:
at a first time:
recording, via the processing circuitry, a temperature associated with the first temperature sensor;
recording, via the processing circuitry, a temperature associated with the second temperature sensor;
at a second time after the first time:
heating the heating element to a first heating temperature using the first power level; and
recording, via the processing circuitry, a temperature associated with the second temperature sensor.

3. The device of claim 2, wherein the method of measuring the temperature external to the housing further comprises:
in accordance with a determination that the temperature associated with the first temperature sensor at the first time and the temperature associated with the second temperature sensor at the second time does not generate the heat flux across the insulator:
calculating, via the processing circuity, the temperature external to the housing based at least on the first power level;
in accordance with a determination that the temperature associated with the first temperature sensor at the first time and the temperature associated with the second temperature sensor at the second time generates the heat flux across the insulator:
increasing from the first power level to a second power level at the heating element, wherein the second power level heats the heating element to a second heating temperature using the second power level, wherein the heating element at the second power level heats the second temperature sensor to an updated temperature; and
in accordance with a determination that the temperature associated with the first temperature sensor at the first time and the updated temperature associated with the second temperature sensor does not generate the heat flux across the insulator:
calculating, via the processing circuitry, the temperature external to the housing based at least on the second power level.

4. The device of claim 2, wherein the method of measuring the temperature external to the housing further comprises in accordance with a determination that the heat flux across the insulator is zero at the first time, outputting, via the processing circuitry, the temperature external to the housing as the first temperature associated with the second temperature sensor.

5. The device of claim 2, wherein the method of measuring the temperature external to the housing further comprises, in accordance with a determination that the heat flux across the insulator is zero at the second time, outputting, via the processing circuitry, the temperature external to the housing as the second temperature associated with the second temperature sensor.

6. The device of claim 1, wherein the first location and the second location are respectively disposed beneath the exterior surface of the device; and
the first temperature sensor exchanges a first amount of thermal energy with the exterior surface of the device across the housing, wherein the second temperature sensor exchanges a second amount of thermal energy, substantially equal to the first amount of thermal energy, with the exterior surface of the device across the housing.

7. The device of claim 6, wherein the second temperature sensor further exchanges the second amount of thermal energy with an environment outside the housing of the device via the exterior surface of the device; and
the second temperature sensor is thermally isolated from the interior of the device by the insulator.

8. The device of claim 1, wherein the insulator forms a dome having a base that is coupled to the housing at the second location of the housing, the insulator and housing at least partially surrounding the heating element and the second temperature.

9. The device of claim 8, wherein the base of the dome and a body of the dome at least partially surround an internal volume including the heating element and the second temperature sensor, wherein a portion of the internal volume is not occupied by the heating element, and the second temperature sensor includes a thermally conductive material.

10. The device of claim 1, wherein the device is configured to be wearable by a user of the electronic device.

11. The device of claim 10, wherein the device is configured to attach to the user such that the first location of the housing of the device and the second location of the housing of the device are not in contact with the user of the device while the device is attached to the user.

12. The device of claim 10, wherein the temperature external to the housing corresponds to a biometric temperature of the user.

13. The device of claim 1, wherein the processing circuitry is further configured to:
detect a first input; and
in response to the first input, initiate the method of measuring the temperature external to the housing during a detection period.

14. The device of claim 1, wherein the method of measuring the temperature external to the housing further includes:
automatically recording the second temperature at predetermined time intervals.

15. The device of claim 1, wherein the temperature external to the housing corresponds to an ambient temperature associated with an environment encapsulating the device.

16. A method of measuring a temperature external to housing of an electronic device comprising:
at the electronic device, wherein the electronic device includes at least a heating element, processing circuitry, an insulator, a first temperature sensor at a first location, and a second temperature sensor at a second location:
heating, via the heating element at a first power level, the second temperature sensor to a first temperature;
recording, via processing circuitry, the first temperature;
recording, via the processing circuitry, a second temperature associated with the second temperature sensor, wherein the first temperature and the second temperature generate a heat flux across the insulator; and
calculating, via the processing circuity, the temperature external to the housing based on the heat flux.

17. The method of claim 16, further comprising:
at a first time:
recording, via the processing circuitry, a temperature associated with the first temperature sensor;
recording, via the processing circuitry, a temperature associated with the second temperature sensor;
at a second time after the first time:
heating the heating element to a first heating temperature using the first power level; and
recording, via the processing circuitry, a temperature associated with the second temperature sensor.

18. The method of claim 16, wherein the first location and the second location are respectively disposed beneath the exterior surface of the device; and
the first temperature sensor exchanges a first amount of thermal energy with the exterior surface of the device across the housing, wherein the second temperature sensor exchanges a second amount of thermal energy, substantially equal to the first amount of thermal energy, with the exterior surface of the device across the housing.

19. A non-transitory computer readable storage medium storing one or more programs, the one or more programs comprising instructions, which when executed by one or more processors of an electronic device, cause the electronic device to perform a method comprising:
at the electronic device, wherein the electronic device includes at least a heating element, processing circuitry, an insulator, a first temperature sensor at a first location, and a second temperature sensor at a second location:
heating, via the heating element at a first power level, the second temperature sensor to a first temperature;
recording, via processing circuitry, the first temperature;
recording, via the processing circuitry, a second temperature associated with the second temperature sensor, wherein the first temperature and the second temperature generate a heat flux across the insulator; and
calculating, via the processing circuity, the temperature external to a housing of the electronic device based on the heat flux.

20. The non-transitory computer readable storage medium of claim 19, wherein the method further comprises:
at a first time:
recording, via the processing circuitry, a temperature associated with the first temperature sensor;
recording, via the processing circuitry, a temperature associated with the second temperature sensor;
at a second time after the first time:
heating the heating element to a first heating temperature using the first power level; and
recording, via the processing circuitry, a temperature associated with the second temperature sensor.
